(19) United States
(12) Patent Application Publication
(10) Pub. No.: US 2026/0302002 A1
(43) Pub. Date: Oct. 1, 2026

(54) COLD SHRINK PRODUCTS FOR ELECTRICAL SYSTEMS AND METHODS FOR FORMING SAME

(71) Applicant: Richards Mfg. Co. Sales, LLC, Irvington, NJ (US)

(72) Inventors: Bruce Bier, Warren, NJ (US); Christopher A. Juillet, Warren, NJ (US); Alexsander J. Lorenzo, Newark, NJ (US); Tao Ni, Westfield, NJ (US)

(21) Appl. No.: 19/548,366

(22) Filed: Feb. 24, 2026

Related U.S. Application Data
(60) Provisional application No. 63/777,404, filed on Mar. 25, 2025.

(51) Int. Cl. H01B 17/58

(52) U.S. Cl. CPC H01B 17/58

(57) ABSTRACT

A cold shrink product for an electrical system includes a tubular elastomeric layer including an inner surface. The inner surface defines a cavity and first retention features facing the cavity. The first retention features are configured to engage second retention features of a mandrel to resist relative displacement between the elastomeric layer and the mandrel during manufacture of the cold shrink product.

### RELATED APPLICATION(S)

The present application claims the benefit of and priority from U.S. Provisional Patent Application No. 63/777,404, filed Mar. 25, 2025, the disclosure of which is incorporated herein by reference.

### FIELD

The present inventions generally relate to cold shrink products for electrical systems, and to methods of manufacturing cold shrink products.

### BACKGROUND

Cold shrink products are commonly employed to protect or shield electrical power cables (e.g., low voltage cables up to about 1000 V and medium voltage cables up to about 46 kV) and connections (e.g., splices or terminations). The cold shrink product may be an electrical connector including a protective housing or may be a cover installed over an electrical connector, for example.

For example, some connectors have molded joints to connect or terminate medium voltage electrical cables (4 kV-35 kV). The molded joints consist of at least three layers of polymers. There is an inner conductor shield, an outer insulation shield, and a middle insulation layer. The outer insulation shield and the inner conductor shield provide electrical functions and have some degree of electrical conductivity. The middle insulation layer provides the insulation between the high voltage electrode of the inner conductor shield and ground potential of the outer insulation shield. A common method of manufacturing the molded joint is to mold the inner conductor shield and the outer insulation shield as separate subcomponents. Then, after properly positioning the molded inner conductor shield and the molded outer insulation shield, the insulation layer is injected through an opening in the outer insulation shield to create the three layer “sandwich.”

During the process of injecting the middle insulation layer, the inner conductor shield is mounted on a mandrel (usually a metal mandrel) to provide support during the injection process. The outer insulation shield is typically supported by the structures associated with the mold cavity. However, it is necessary for the outer insulation shield and the inner conductor shield to remain substantially in place during the injection of the insulation. Any stretching or distortion of the elastomeric inner conductor shield or the elastomeric outer insulation shield during the injection of insulation is likely to cause a manufacturing defect in the molded electrical connector, such that it fails from a quality control standpoint. To ensure proper positioning of the inner conductor shield or the outer insulation shield, it is necessary to inject the middle insulation layer at a very slow speed resulting in very long cycle times between molded parts. This is especially true of cold shrink parts that typically have lower modulus and high elongation as compared with standard elastomers. The inner conductor shield, which is pre-mounted on the mandrel, is especially subject to stretching as the insulation is injected. In some cases, it is possible to use a textured surface on the mandrel (e.g., a knurled surface) to create more friction between the inner surface of the inner conductor shield and the mandrel. However, this texturing can, in some cases, damage surfaces, (e.g., on the inner surface of the inner conductor shield or at the insulation layer that will interface with the cable assembly) when the mandrel is removed after the insulation injection process has been completed.

Consequently, there is a need for a more efficient method of manufacturing a multi-layer molded cold shrink product that is used to cover a connection or that forms a protective housing of a connector, such as an elbow connector.

### SUMMARY

In one aspect, a cold shrink product for an electrical system includes a tubular elastomeric layer including an inner surface. The inner surface defines a cavity and first retention features facing the cavity. The first retention features are configured to engage second retention features of a mandrel to resist relative displacement between the elastomeric layer and the mandrel during manufacture of the cold shrink product.

In a further aspect, a method for forming a cold shrink product for an electrical system, the cold shrink product including a tubular elastomeric layer including an inner surface defining a cavity and first retention features facing the cavity, the cavity being configured to receive an electrical cable, includes: mounting the elastomeric layer on a mandrel such that the first retention features of the elastomeric layer engage second retention features of the mandrel; and injecting a material along an outer surface of the elastomeric layer to form a second layer on an outer surface of the elastomeric layer, wherein engagements between the first and second retention features resist relative displacement between the elastomeric layer and the mandrel as the material is injected.

In a further aspect, a cold shrink product for an electrical system includes an inner conductor shield, an outer conductor shield, and an insulation material. The inner conductor shield has an inner surface defining a generally cylindrical cavity for receiving an electrical cable. The generally cylindrical cavity has a central axis. The inner surface has a plurality of circumferential projections extending toward the central axis, each of the plurality of circumferential projections being longitudinally spaced along the central axis from an adjacent one the plurality of circumferential projections. The outer insulation shield surrounds the inner conductor shield. The outer insulation shield is spaced away from the inner conductor shield. The insulation material is located between the inner conductor and the outer insulation shield.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a cross-sectional view of an elbow connector according to some embodiments shown mounted on a terminated cable assembly and engaged with an electrical equipment termination.

FIG. 2 is a perspective view of a protective housing forming a part of the elbow connector of FIG. 1.

FIG. 3 is a side view of the protective housing of FIG. 2.

FIG. 4A is a cross-sectional view of the protective housing of FIG. 2.

FIG. 4B is an enlarged cross-sectional view of a portion of the protective housing in FIG. 4A adjacent to a cable-receiving cavity.

FIG. 5 is a perspective view of an inner conductor shield of the protective housing of FIG. 2.

FIG. 6 is a side view of the inner conductor shield of FIG. 5.

FIG. 7 is a cross-sectional view of the inner conductor shield of FIG. 5.

FIG. 8 is an enlarged cross-sectional view of a portion of the inner surface of the inner conductor shield in FIG. 7 that shows the plurality of projections on the inner surface.

FIG. 9A is a side view of a mandrel used with the inner conductor shield of FIG. 5.

FIG. 9B is an enlarged side view of a portion of the mandrel in FIG. 9A showing the geometric features of the mandrel that mate with the plurality of protrusions on the inner surface of the inner conductor shield.

FIG. 10A is a cross-sectional view of the mandrel of FIG. 9A disposed within the inner conductor shield of FIG. 5 during an example manufacturing process.

FIG. 10B is an enlarged cross-sectional view of a portion of FIG. 10A showing the mating surfaces of the mandrel and the inner conductor shield.

FIG. 11 is a side view of a protective splice joint body according to some embodiments.

FIG. 12 is a cross-sectional view of the protective splice joint body of FIG. 11.

FIG. 13 is an enlarged cross-sectional view of the protective splice joint body of FIG. 11.

### DETAILED DESCRIPTION

The present technology now will be described more fully hereinafter with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It is noted that aspects described with respect to one embodiment may be incorporated in different embodiments although not specifically described relative thereto. That is, all embodiments and/or features of any embodiments can be implemented separately or combined in any way and/or combination. Moreover, other apparatus, methods, and systems according to embodiments of the concepts will be or become apparent to one with skill in the art upon review of the following drawings and detailed description. It is intended that all such additional apparatus, methods, and/or systems be included within this description, be within the scope of the present subject matter, and be protected by the accompanying claims.

As used herein, “cold shrink” or “cold shrink cover” means that the cover or component can be shrunk or contracted about a substrate (e.g., a cable) without requiring the use of applied heat. As used herein, “cold-applied” or “cold-applied cover” means that the cover or component can be assembled or installed about a substrate (e.g., a cable) without requiring the use of applied heat at the time of installation.

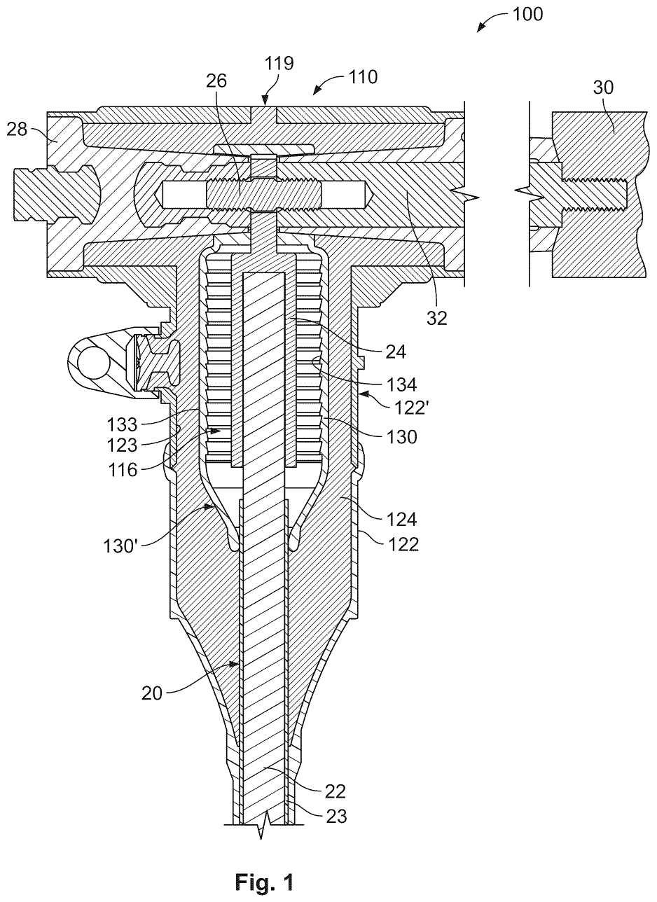

With reference to FIGS. 1-8, a multi-layer cold shrink product 100 according to some embodiments is shown therein. The illustrated cold shrink product 100 is an electrical elbow connector and may be referred to as “the elbow connector 100” hereinbelow. The elbow connector 100 (FIG. 1) includes an electrical termination or cable connector 24 (e.g., a cable lug connector), and a protective housing 110. As discussed herein, cold shrink products according to embodiments of the technology make take other forms and be of different types. For example, a cold shrink product according to some embodiments may be a disconnectable sleeve connector or a splice joint body.

The elbow connector 100 may be used to terminate and environmentally protect an electrical cable 22 (in some embodiments, an electrical power transmission cable) and to enable physical and electrical connection between the cable 22 and a termination (e.g., a bushing 32) of associated electrical equipment 30 as shown in FIG. 1, for example. For example, the cable connector 24 may be installed on an end of the cable 22 to form a terminated cable assembly 20. The terminated cable assembly 20 may in turn be inserted into the protective housing 110. The terminated cable assembly 20 may be inserted into the protective housing 110 while the protective housing 110 is held in a radially expanded state (e.g., by a holdout), and the protective housing 110 may be permitted to elastically radially contract (e.g., by removing the holdout) to collapse the protective housing 110 onto the terminated cable assembly 20 as shown in FIG. 1, for example. The elbow connector 100 can then be pushed onto the equipment connector 32 and coupled with a contact member 26 and a retainer 28, for example.

It will be appreciated that the elbow connector 100 and the other components may be otherwise configured. As one example, the elbow connector 100 (or a T-body joint connector) can be used for connecting cables to transformers, switches, junctions, or other medium voltage equipment. Elbow joints can also be stacked together to connect multiple cables.

With reference to FIGS. 1-3, the protective housing 110 is a body including a main body portion 112 and a transverse end portion 114 that forms a T-shape with the main body portion 112. The protective housing 110 is just one example of various types and configurations for elbow connectors (and connectors generally) that may incorporate or be used with the disclosed technology.

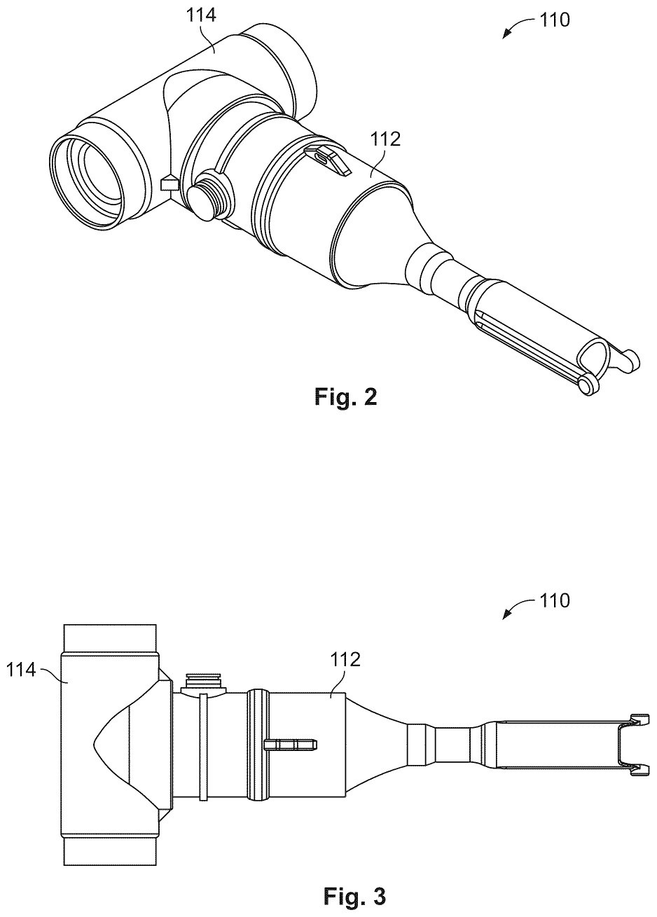

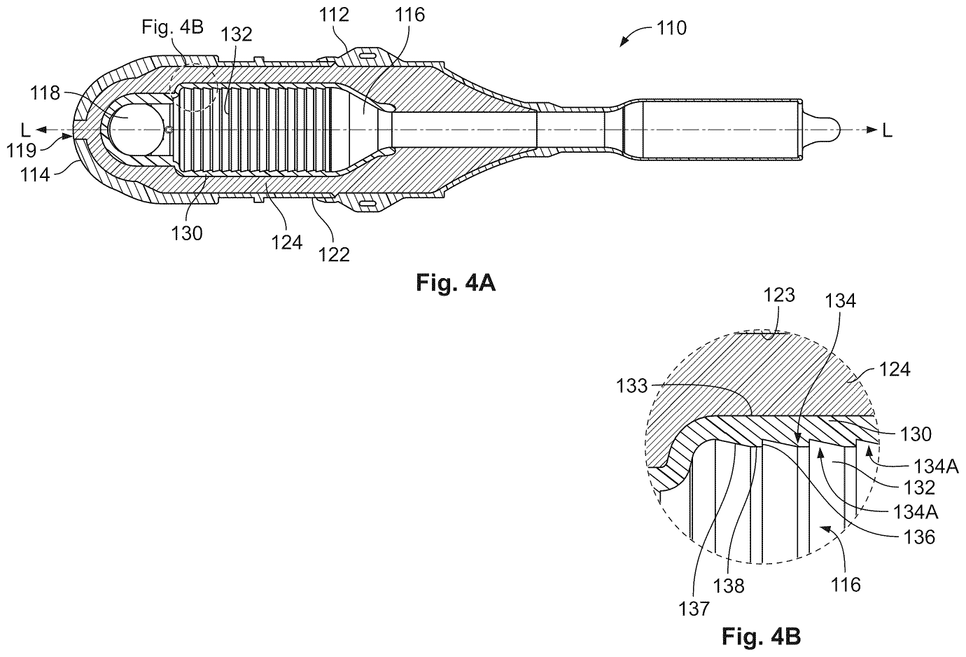

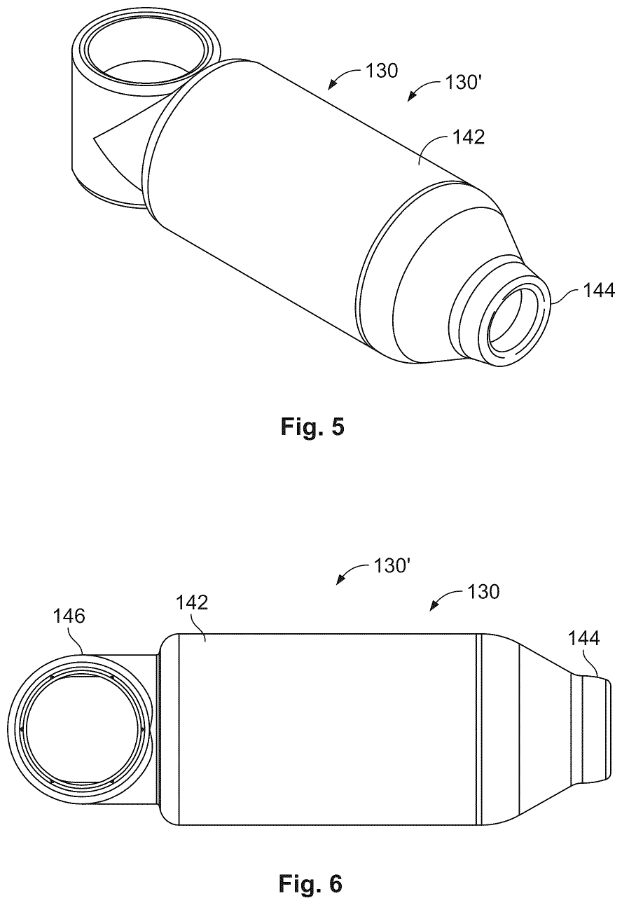

FIG. 4A illustrates a cross-sectional view of the protective housing 110 of FIG. 2 along a central axis L-L of the main body portion 112. The main body portion 112 defines a generally cylindrical cable-receiving cavity 116 configured to receive the electrical cable assembly 20. As shown in FIG. 4A, the main body 112 is formed from three layers of material, namely: an outer layer 122, a second layer 124, and an elastomeric layer 130. The elastomeric layer 130 may be referred to herein as the inner elastomeric layer 130. The second layer 124 is referred to herein as the middle layer 124 and is located between the outer layer 122 and the inner elastomeric layer 130.

In some embodiments, the outer layer 122 forms an outer insulation shield 122′ of the protective housing 110. In some embodiments, the outer layer 122 forms the exterior structure of the main body portion 112. In some embodiments, the outer layer 122 is elastomeric.

In some embodiments, the inner elastomeric layer 130 forms an inner conductor shield 130′ of the protective housing 110. The inner elastomeric layer 130 includes an inner surface 132 that defines the generally cylindrical cavity 116 that receives the electrical cable assembly 20.

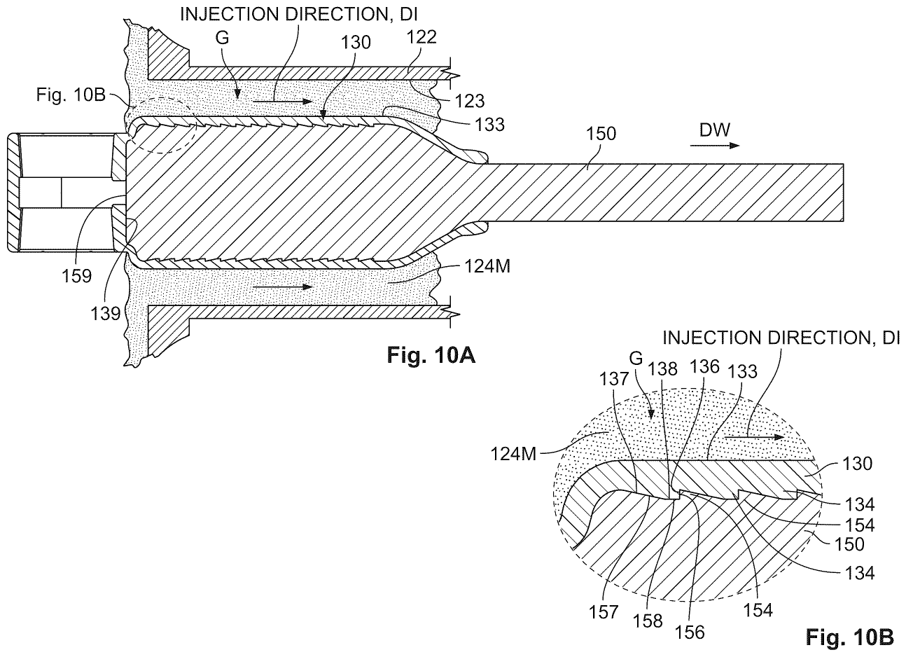

The middle layer 124 is positioned between the outer layer 122 and the inner elastomeric layer 130. In some embodiments and as illustrated, the middle layer 124 constitutes an electrical insulation layer between the inner conductor shield 130′ and the outer insulation shield 122′ and may be referred to as an electrically insulating layer. In some embodiments, the middle layer 124 is elastomeric. As described in more detail relative to FIGS. 10A and 10B, an opening 119 in the transverse end portion 114 is used for injecting the material that forms the middle layer 124 between the outer layer 122 and the inner elastomeric layer 130.

In the illustrated example, the cable assembly 20 (FIG. 1) includes the electrical cable 22 and the lug 24 at the terminal lead end of the cable 22. The lug 24 has an aperture therein. The cable assembly 20 is inserted into the protective housing 110 such that the lug 24 is inserted all the way into a central hole 118 of the protective housing 110 at a central portion of the transverse end portion 114. In the central hole 118, the lug's aperture can then be aligned with a fastener or other device that is inserted through one or both openings within the transverse end portion 114.

In some embodiments, the inner conductor shield 130′ is a Faraday cage and the protective housing 110 is configured such that the inner conductor shield 130′ surrounds the connector 24 when the cable assembly 20 is installed in the protective housing 110. In some embodiments, the inner conductor shield 130′ surrounds and engages a section of polymeric insulation 23 of the cable 22. The inner conductor shield 130′ may thereby provide electrical stress control within the protective housing 110.

In some embodiments, the outer insulation shield 122′ is an electrical ground shield layer. The outer insulation shield 122′ may be electrically connected to an electrical ground (e.g., via a drain wire) as is known in the art.

FIG. 4B illustrates an enlarged cross-sectional view of a portion of the protective housing 110 in FIG. 4A adjacent to the generally cylindrical cavity 116. The inner surface 132 of the inner elastomeric layer 130 defines the generally cylindrical cavity 116. The inner surface 132 includes a set or plurality of first retention features 134 facing the cavity 116. In some embodiments (e.g., as illustrated), the first retention features 134 are projections or protrusions 134. The protrusions 134 extend along a substantial portion of the axial length of the inner elastomeric layer 130. The protrusions 134 are serially arranged or distributed along the central axis L-L and face and project or protrude into the cavity 116. In the illustrated embodiment of FIGS. 4A and 4B, the plurality of protrusions 134 forms a sawtooth profile when viewed in cross-section along an axial plane. In some embodiments, the protrusions 134 cover a majority of the inner surface 132. The protrusions 134 define a set or plurality of grooves 134A between adjacent protrusions 134 such that the protrusions 134 and grooves 134A alternate along the length of the cavity 116.

As shown in FIGS. 4A and 4B, the protrusions 134 project radially into the cavity 116. The protrusions 134 extend radially toward the central axis L-L. In some embodiments, the protrusions 134 and grooves 134A each extend circumferentially about the central axis L-L. In some embodiments, the protrusions 134 and grooves 134A are each annular (i.e., form a continuous, unbroken ring) and surround the central axis L-L. That is, in some embodiments, the protrusions 134 are annular ribs and the grooves 134A are annular grooves.

With reference to FIGS. 4A and 4B, each protrusion 134 has a radially extending first or front surface 136, which extends toward the central axis L-L of the generally cylindrical cavity 116 and the main body 112, and a ramped or tapered rear surface 137. An axially extending third surface 138 is located between the front surface 136 and the rear surface 137.

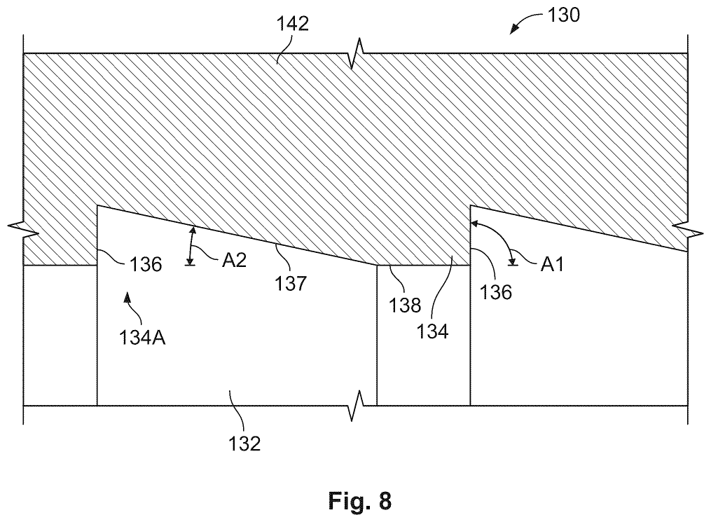

In some embodiments, the front surface 136 forms a first angle A1 relative to the central axis L-L, the rear surface 137 forms a second angle A2 relative to the central axis L-L, and the first angle A1 is steeper than the second angle A2 (FIG. 8). That is, the rear surface 137 is axially sloped or tapered (relative to the central axis L-L) and the front surface 136 is either perpendicular to or is less sloped than the rear wall 137. In some embodiments, the third surface 138 is substantially parallel to the central axis L-L. In some embodiments, the front surface 136 is longer than the rear surface 137.

As explained further below, the plurality of protrusions 134 assist in the manufacturing process of the protective housing 110. Though a sawtooth-shaped profile for the protrusions 134 is illustrated, the plurality of protrusions 134 can take various shapes and can be, for example, rounded-shaped ribs (e.g., asymmetric ribs having longer surfaces on one side of the midpoint of the rib and shorter, more perpendicular surfaces on the other side) that extend circumferentially entirely around the inner surface 132 of the inner elastomeric layer 130.

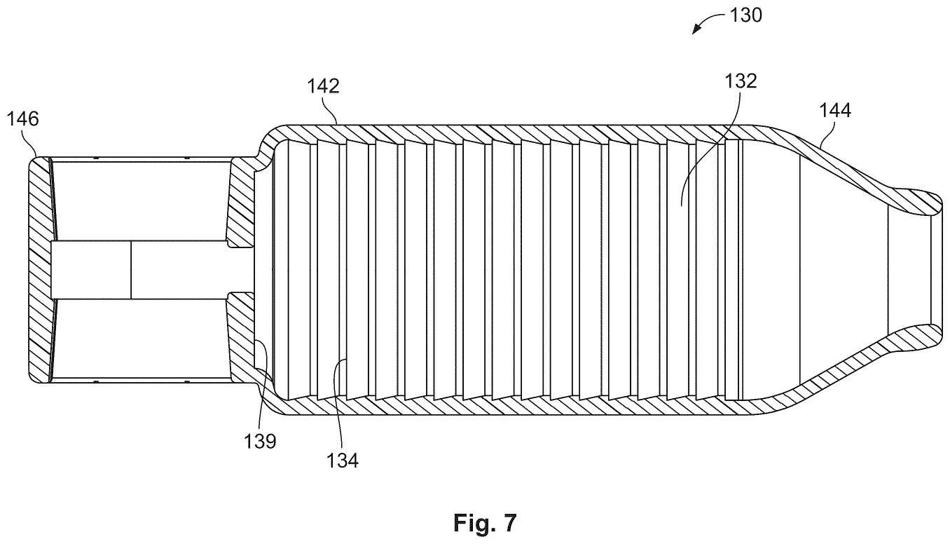

FIGS. 5 and 6 illustrate a perspective view and a side view, respectively, of the inner conductor shield 130′ (formed by the inner elastomeric layer 130) of the elbow connector 100 in FIGS. 1-2. The inner conductor shield 130′ includes a tubular central portion 142, which includes the inner surface 132 (FIG. 7), a cable-entry end 144, and a connecting end 146. The cable-entry end 144 receives the cable assembly 20 that is inserted into the protective housing 110. The connecting end 146 is the location of the connection between the cable assembly (e.g., the lug 24 of the cable assembly 20) and fasteners or other components that are inserted within the transverse end 114 of the elbow connector 100.

The inner elastomeric layer 130 (i.e., the inner conductor shield 130′) may be formed of any suitable material. In some embodiments, the inner elastomeric layer 130 is formed is a semiconductive elastomer. In some embodiments, the inner elastomeric layer 130 is a flexible and resilient material that includes electrically conductive particles or fibers embedded therein. As one example, the inner conductor shield 130 can be made of an elastomer with an EMI shielding function, such as cold-shrink conductive ethylene-propylene diene monomer (EPDM) in which the conductivity is provided by carbon black fibers. In some embodiments, the inner elastomeric layer 130 is monolithic.

The outer layer 122 (i.e., the outer insulation shield 122′) may be formed of any suitable material. In some embodiments, the outer layer 122 is formed of an elastomer. In some embodiments, the outer layer 122 is a semiconductive elastomer. In some embodiments, the outer layer 122 is a blend of EPDM and nitrile rubber compounds. In some embodiments, the outer layer 122 is monolithic.

The middle layer 124 may be formed of any suitable material. In some embodiments, the middle layer 124 is formed of an elastomer. In some embodiments, the middle layer 124 is an electrically insulating material. In some embodiments, the middle layer 124 is an electrically insulating elastomer. In some embodiments, the middle layer 124 is monolithic.

In some embodiments, the inner conductor shield 130′ has a maximum outer diameter between 1.5 inches and 3 inches, such as 2.25 inches, and the molded overall wall thickness of the inner conductor shield 130′ is between about 0.1 inch and 0.25 inch, such as 0.125 inch. In some embodiments, the outer insulation shield 122′, which serves as the exterior layer of the elbow connector 100, has a maximum outer diameter between 2 inches and 4 inches.

FIG. 7 illustrates a cross-sectional view of the inner elastomeric layer 130 showing the plurality of protrusions 134 on the inner surface 132. FIGS. 4B and 8 are enlarged cross-sectional views in the central portion 142 that show the protrusions 134 on the inner surface 132. FIG. 8 shows details of the short radially extending front surface 136, which is preferably perpendicular or generally perpendicular (i.e., the first angle A1 is roughly 90 degrees) to the central axis L-L of the generally cylindrical cavity 116 and the main body 112. The long angled rear surface 137, when projected toward the central axis L-L, forms the second angle A2 with the central axis L-L that is preferably between 10 degrees and 30 degrees, such as about 20 degrees. The axially extending third surface 138 is located between the front surface 136 and the rear surface 137. In some embodiments, the front surface 136 has a dimension between 0.025 inch and 0.050 inch, such as 0.040 inch. In some embodiments, the rear surface 137 has a dimension between 0.125 inch and 0.225 inch, such as 0.188 inch. In some embodiments, the rear surface 138 is larger than the front surface 136 and may have a dimension between 0.040 inch and 0.080 inch, such as 0.060 inch.

The sawtooth profile in FIG. 4B can take various forms and shapes as defined by the sizes, dimensions, and number of surfaces defining each projection 134. As one example, though FIGS. 4B, 7 and 8 disclose an embodiment in which each projection 134 has the long angled rear surface 137 that merges into the short radially extending front surface 136 of the adjacent projection 134, in other embodiments, there can be spacing between each adjacent projection 134. In other examples, each sawtooth-profile projection 134 can be defined by only two surfaces or have more of a rounded profile.

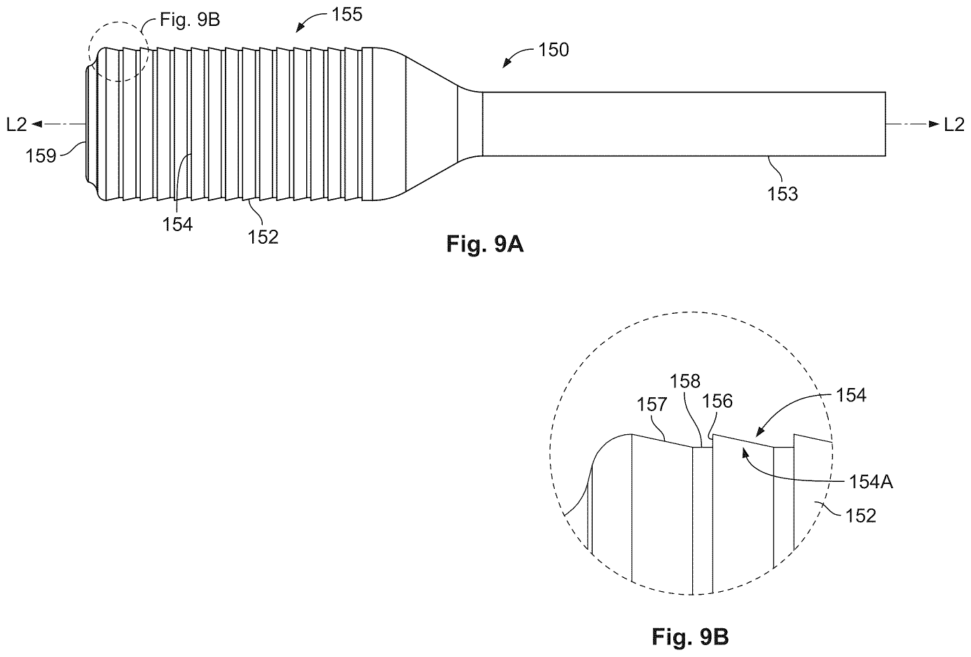

FIG. 9A illustrates a side view of a mandrel 150 that can be used in conjunction with the inner elastomeric layer 130 (i.e., the inner conductor shield 130′) of FIG. 7 during the manufacturing process of the protective housing 110. The mandrel 150 includes a main body 152 and an elongated stem 153. The main body 152 includes a set or plurality of second retention features 154 formed or defined on an outer surface 155 of the mandrel 150. The second retention features 154 correspond to the first retention features (protrusions) 134 of the inner elastomeric layer 130 and allow the mandrel 150 to mate with the first retention features 134, as illustrated in FIGS. 10A and 10B.

As shown in FIGS. 9A and 9B, the second retention features 154 are in the form of a plurality of projections or protrusions 154 that extend along a substantial portion of the length of the mandrel 150. The protrusions 154 are serially arranged along a central axis L2-L2 of the mandrel 150 and face and project or protrude radially outward with respect to the central axis L2-L2. The central axis L2-L2 is parallel to, and in some embodiments coaxial with, the central axis L-L when the mandrel 150 is inserted in the inner conductor shield 130′. In the illustrated embodiment of FIGS. 3A-3B, the plurality of protrusions 154 forms a sawtooth profile. The protrusions 154 define a set or plurality of grooves 154A therebetween such that the protrusions 154 and grooves 154A alternate along the length of the mandrel 150.

As shown in FIGS. 9A and 9B, for example, the external protrusions 154 project radially outward. In some embodiments, the protrusions 154 and grooves 154A each extend circumferentially about the central axis L2-L2. In some embodiments, the protrusions 154 and grooves 154A are each annular (i.e., form a continuous, unbroken ring) and surround the central axis L2-L2. That is, in some embodiments, the protrusions 154 are annular ribs and the grooves 154A are annular grooves.

Each protrusion 154 has a short, radially extending first or front surface 156, which extends radially from the central axis L2-L2 (and radially away from the of the central axis L-L when the mandrel 150 is inserted into the cavity 116), and a long angled, ramped or tapered rear surface 157. An axially extending third surface 158 is located between the front surface 156 and the rear surface 157. In some embodiments (e.g., as illustrated), the front surface 156 forms a first angle relative to the central axis L2-L2, the rear surface 157 forms a second angle relative to the central axis L2-L2, and the first angle is steeper than the second angle. That is, the rear surface 157 is axially sloped or tapered (relative to the central axis L-L) and the front surface 156 is either perpendicular to or is less sloped than the rear wall 157. In some embodiments, the third surface 158 is substantially parallel to the central axis L2-L2.

As discussed herein, the external retention features 154 on the exterior or outer surface 155 of the mandrel 150 are adapted or arranged and configured to mate or interlock with the internal retention features 134 on the interior or inner surface 132 of the inner elastomeric layer 130. In some embodiments and as illustrated, the second retention features 154 are geometrically shaped to be substantially a mirror image of the shapes of the projections 134 on the inner elastomeric layer 130 inner conductor shield 30. That is, the respective profiles of the mating sections (as discussed herein) of the inner surface 132 of the inner elastomeric layer 130 and the outer surface 155 of the mandrel 150 are substantially fully congruent and substantially fully conform to one another.

The mandrel 150 may be made from any high strength, rigid, wear-resistant material that can withstand high-temperature molding. In some embodiments, the mandrel 150 is made from metal, such as steel, and, in some embodiments, a hardened alloy steel (tool steel).

In accordance with methods according to some embodiments, the elbow connector 100 may be manufactured as follows using the mandrel 150.

In some embodiments, the inner elastomeric layer 130 is pre-formed as a body as shown in FIGS. 5 and 7. In some embodiments, the inner elastomeric layer 130 is molded (e.g., injection molded).

Thereafter, the mandrel 150 is inserted into the cavity 116 of the pre-formed inner elastomeric layer 130. By “inserted”, it is meant that the mandrel 150 is placed in the cavity 116 by moving the mandrel 150 relative to the inner elastomeric layer 130, moving the inner elastic layer 130 relative to the mandrel 150, or both. In this step, the inner elastomeric layer 130 is first elastically radially expanded (e.g., using a tool or fixture) and the mandrel 150 is inserted into the cavity 116 while the inner elastomeric layer 130 is in the expanded state. The expansion allows the protrusions 154 of the mandrel 150 to pass into the cavity 116 and by the protrusions 134 without dragging on the protrusions 134 or with reduced drag so that the protrusions 154 do not damage or distort the inner elastomeric layer 130.

The tool is then removed to permit the inner elastic layer 130 to elastically radially contract and engage the mandrel 150. The inner elastomeric layer 130 is axially aligned with the mandrel 150 such that the protrusions 134 seat in the grooves 154A and the protrusions 154 seat in the grooves 134A, as shown in FIGS. 10A and 10B. Registry or alignment between the retention features 134, 154, 134A, 154A can be assured by relatively configuring the components 130, 150 such that the retention features 134, 154, 134A, 154A are properly aligned when the leading end wall 159 of the mandrel 150 abuts the rear wall 139 of the inner elastomeric layer 130.

The outer layer 122 is pre-formed (e.g., molded) as a body and installed around the inner elastomeric layer 130 mounted on the mandrel 150 as described above. The outer layer 122 is mounted such that a void or gap G is defined between the pre-formed layers 122 and 130 and, more particularly, between the outer surface 133 of the inner elastomeric layer 130 and the inner surface 123 of the outer layer 122, as shown in FIGS. 10A and 10B. The gap G extends axially. In some embodiments, the gap G also extends circumferentially about the cavity 116 such that at least portions of the gap G are annular.

A material 124M for forming the middle insulation layer 124 is then injected into the gap G between the outer layer 122 (i.e., the outer insulation shield 122′) and inner elastomeric layer 130 (i.e., the inner conductor shield 130′) through the opening 119 (FIG. 3A) in the transverse end 114. FIGS. 10A and 10B show the injection direction DI of the flowing material 124M that forms the middle insulation layer 124. In FIGS. 10A and 10B, the material 124M is shown only partially injected and partially filling the gap G. The injection of the material 124M causes forces to be applied to the outer surface 133 of the inner elastomeric layer 130 and also the inner surface 123 of the outer layer 122 (not shown in FIGS. 10A-10B). Because the outer layer 122 and the inner elastomeric layer 130 must be maintained at fixed relative positions, these forces must be resisted to keep the outer layer 122 and the inner elastomeric layer 130 in their correct relative positions and shapes.

To resist the forces from the injected middle insulation layer 124, the outer layer 122 can be held in place by a mechanical device that holds the inner surface 123 of the outer layer 122 in place. The inner elastomeric layer 130 is held in place by the mandrel 150 and, specifically, by the engagement between the protrusions 134 and the retention features 154. As shown in FIG. 10B, the front surfaces 136 of the protrusions 134 engage respective ones of the front surfaces 156 of the protrusions 154 to thereby resist axial displacement of the inner elastomeric layer 130 relative to the mandrel 150 in the direction DI. The protrusions 134 mechanically interlock with the protrusions 154. The surfaces 136, 156 are transverse to the flow direction DI of the injected material 124M of the middle layer 124 (and the central axis L-L of the inner elastomeric layer 130 and its generally cylindrical cavity 116) and, in some embodiments, at about 90 degrees. In this way, engagement between the features 134, 154 prevents or reduces the occurrence of stretching, distortion or deformation of the inner elastomeric layer 130 that would otherwise be caused by the forces from injection of the middle layer material 124M. In this way, engagement between the features 134, 154 may also resist axial displacement of the inner elastomeric layer 130 relative to the outer layer 122.

Additionally, because the mating profiles of the inner surface 132 and the outer surface 155 are mirror image congruent, the protrusions 134 substantially fully complement and fill the grooves 154A and the protrusions 154 substantially fully complement and fill the grooves 134A. As a result, there is little or no air captured between the mandrel 150 and the inner elastomeric layer 130. This eliminates or reduces the risk that air pockets may be compressed by the injection forces, permitting undesired deformation of the inner elastomeric layer 130.

The entire gap G between the outer layer 122 and the inner elastomeric layer 130 may be filled with the middle insulation layer material 124M to thereby create the middle insulation layer 124. In some embodiments, the injected material 124M will cool, stiffen and bond to the surfaces 123, 133. The middle layer 124 may have an annular cross-sectional shape.

Thereafter, the mandrel 150 is removed from the cavity 116 and the formed cold shrink product 110. When the mandrel 150 is inserted, the middle layer 124 may also engage parts of the mandrel 150, such as at its stem 153, as can be visualized by the final location and shape of the middle layer 124 in FIG. 4A.

To remove the mandrel 150, the mandrel 150 may be withdrawn in direction DW (FIG. 10A) so that the ramped rear surfaces 157 of the mandrel 150 slide over the series of ramped rear surfaces 137 of the projections 134 to the right in FIGS. 10A and 10B. Because of the slight angle of the rear surfaces 137, 157, there is less resistance and pulling force on the inner elastomeric layer 130 as the mandrel 150 is being retracted. Because the middle layer 124 is also formed of a resilient elastomeric material, it expands around the larger main body 152 as the mandrel 150 is retracted, resulting in a structure of the protective housing 110 that is shown in FIG. 4A.

As such, the present disclosure allows for higher velocity injection speeds for the middle layer 124 than prior art systems and, thus, faster filling of the annular gap G between the inner elastomeric layer 130 and the outer layer 122. In addition to the shorter cycle times in the manufacturing process, the final protective housing 110 has less marring of the surfaces that encounter the mandrel 150 as it is retracted from the inner elastomeric layer 130.

As disclosed herein, in some embodiments the protective housing 110 is constructed such that the inner elastomeric layer 130 is an inner conductor shield, the outer layer 122 is an elastomeric outer insulation shield, and the middle layer 124 is an electrical insulation layer. In this case, the layers 130 and 122 may be semiconductive elastomers and the layer 124 may be an electrically insulating elastomer. However, in other embodiments, one or more of the layers may be formed of other materials having different properties, the outer layer may be omitted, and/or additional layers may be included in a protective housing as disclosed herein.

Although the technology disclosed herein has been described as being useful for electrical connectors, such as elbow connectors and T-body joints, the use of geometrically shaped mandrel (e.g., saw-tooth shape) and correspondingly shaped internal surface on other cold shrink products, such as splices, which join two cables together. The technology disclosed herein may also be used on cold-shrink disconnectable sleeves that connect a cable to a separable joint. The sleeves or splices can be comprised of multiple layers, like the elbow connector described above.

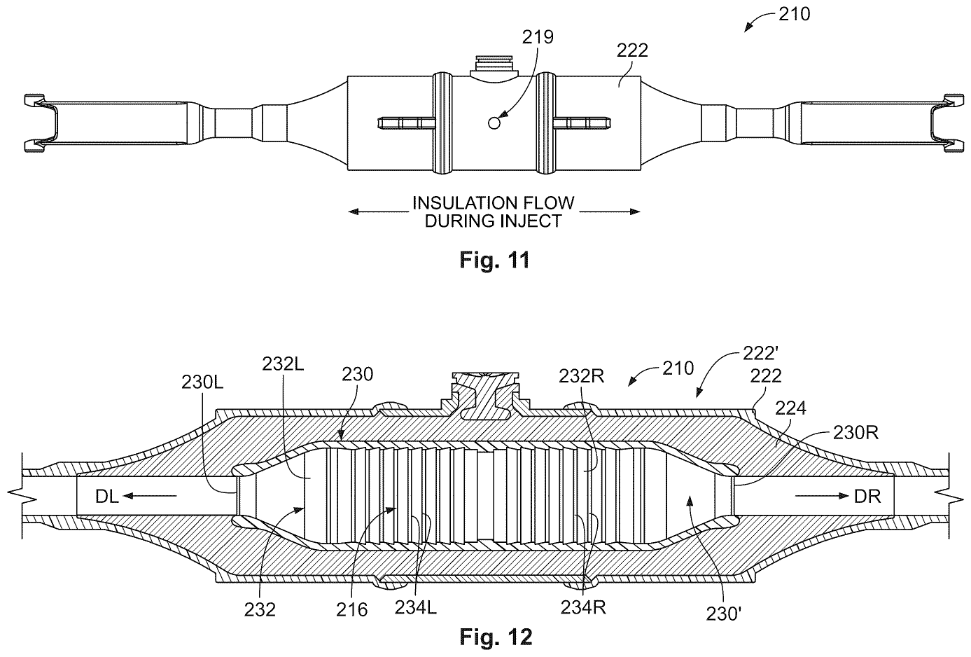

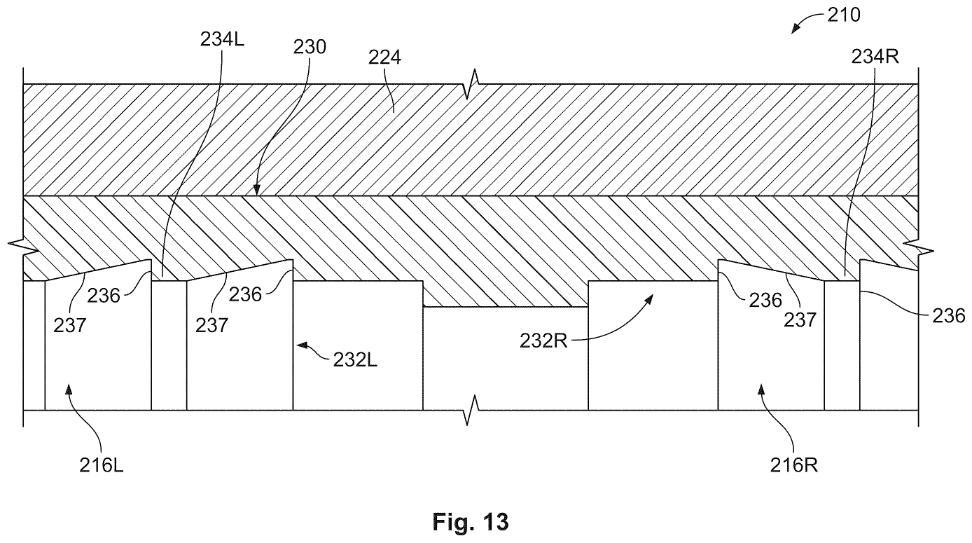

With reference to FIGS. 11-13, a cold shrink product according to further embodiments is shown therein in the form of a protective splice joint body 210. The protective splice joint body 210 may be used to cover an electrical cable splice connection. A cable splice connection can be formed by an electrical splice connector joining two opposed electrical cable ends. The splice joint body 210 can be mounted over the connection such that the splice joint body 210 surrounds the connector and also extends over portions of the joined cables.

The splice joint body 210 includes an outer layer 222 (forming an outer insulation shield 222′), a middle layer 224, and an inner elastomeric layer 230 (forming an inner conductor shield 230′) corresponding to the layers 122 (shield 122′), 124, and 130 (shield 130′), respectively, of the protective housing 110. The protective housing 210 may be constructed and manufactured in the same manner as described herein for the protective housing 110, except as follows. The middle layer 224 may be an electrically insulating elastomer.

The outer layer 222 includes laterally opposed injection openings 319 (only one shown in the figures) defined therein.

The inner elastomeric layer 230 of the splice joint body 210 is tubular and defines a cavity 216, a first end opening 230R, and an opposing second end opening 230L. An inner surface 232 of the inner elastomeric layer 230 includes a first inner surface section 232R defining a first subcavity 216R adjacent the first end opening 230R. The inner surface 232 includes a second inner surface section 232L defining a second subcavity 216L adjacent the second end opening 230L.

First retention features in the form of first protrusions 234R are defined on the first inner surface section 232R and face into the first subcavity 216R. Second retention features in the form of second protrusions 234L are defined on the second inner surface section 232L and face into the second subcavity 216L. The protrusions 234R and 234L may be formed as described for the protrusions 134. The first protrusions 234R are configured such that their first surfaces 236 (e.g., the perpendicular surfaces) face the first end opening 230R. The second protrusions 234L are configured such that their first surfaces 236 (e.g., the perpendicular surfaces) face the opposing second end opening 230L.

The splice joint body 210 may be manufactured as follows in accordance with some method embodiments. In the manufacture of the splice joint body 210, two mandrels corresponding to the mandrel 150 are used. The first mandrel has external retention features (corresponding to the retention features 154) that are mirror images of the first protrusions 234R. The second mandrel has external retention features (corresponding to the retention features 154) that are mirror images of the second protrusions 234L.

With the inner elastomeric layer 230 expanded, the first mandrel is inserted into the first subcavity 216R until the first retention features of the first mandrel are axially aligned with the first protrusions 234R, and the second mandrel is inserted into the second subcavity 216L until the second retention features of the second mandrel are axially aligned with the second protrusions 234L. The first and second mandrels may be inserted through the same opening 230R or 230L. Alternatively, the first mandrel may be inserted through the opening 230R (in a direction opposite direction DR) and the second mandrel may be inserted through the opening 230L (in a direction opposite direction DL). After the first and second mandrels are in place in the subcavities 216R, 216L, the inner elastomeric layer 230 is released to retract onto the two mandrels.

The middle layer 224 material (corresponding to the material 124M) is then injected through the openings 219 into the gap G between the outer layer 222 and the inner elastomeric layer 230 as described herein. The entire gap G between the outer layer 222 and the inner elastomeric layer 230 may be filled with the middle layer 224 material to thereby create the middle insulation layer 224. In some embodiments, the injected material will cool and bond to the inner surface of the outer layer 222 and the outer surface of the inner elastomeric layer 230.

The first and second mandrels are thereafter retracted from the inner elastomeric layer 330 in directions DL and DR, respectively. Notably, the ramped surfaces 237 of the protrusions 234R, 234L are oriented in opposite directions to facilitate removal of the respective mandrels.

In one aspect, the present technology solves the aforementioned problems in the prior art by including one or more projections molded into the inner surface of the inner conductor shield. The shape of the projection(s) may have a “sawtooth” profile in which one surface is perpendicular or substantially perpendicular to the longitudinal axis of the part, and the other surface is tapered to an angle of less than 90 degrees. Likewise, the mandrel has matching geometric features to mate with the projection(s) on the inner surface of the inner conductor shield. The substantially perpendicular surface of the projection acts as an interlock to prevent the inner conductor shield from stretching along the longitudinal surface of the inserted mandrel during injection of middle insulation layer. The tapered surface of the projection(s) allows for the mandrel to be removed during de-molding without damaging the projections on the inner conductor shield or the insulation surface that will interface with the cable assembly.

In another aspect, an elbow connector for an electrical system comprises an inner conductor shield, an outer insulation shield, and insulation material. The inner conductor shield has an inner surface defining a generally cylindrical cavity for receiving an electrical cable. The generally cylindrical cavity has a central axis. The inner surface has a plurality of circumferential projections extending toward the central axis that are configured to mate with corresponding features on a mandrel during the manufacturing of the elbow connector. The outer insulation shield surrounds the inner conductor shield. The outer insulation shield is spaced away from the inner conductor shield such that outer insulation shield and the inner conductor shield define an insulator gap therebetween. The insulation material is located in the insulation gap. The insulation material is injected into the insulator gap while the corresponding features on the mandrel engage the plurality of circumferential projections.

In a further aspect, a connector for an electrical system comprises an inner conductor shield, an outer insulation shield, and insulation material. The inner conductor shield has an inner surface defining a generally cylindrical cavity for receiving an electrical cable. The generally cylindrical cavity has a central axis. The inner surface has a plurality of circumferential projections extending toward the central axis. Each of the plurality of circumferential projections is longitudinally spaced along the central axis from an adjacent one the plurality of circumferential projections. The outer insulation shield surrounds the inner conductor shield. The outer insulation shield is spaced away from the inner conductor shield. The insulation material is located between the inner conductor and the outer insulation shield.

In another aspect, a method is provided for manufacturing an electrical connector that receives an electrical cable. The connector including an outer insulation shield and an inner conductor shield that defines a generally cylindrical cavity for receiving the electrical cable. The method comprises (i) inserting a mandrel into the generally cylindrical cavity, the mandrel having external features that mate with a plurality of circumferential projections on an inner surface of the inner conductor shield, (ii) after the mandrel is inserted, injecting insulation into a gap between the inner conductor shield and the outer insulation shield, and (iii) after gap has been filled with insulation, retracting the mandrel from the generally cylindrical cavity.

Embodiments of the inventive technology can provide a more efficient method of manufacturing a multi-layer molded cold shrink product that is used to cover a connection or that forms a protective housing of a connector, such as an elbow connector. Embodiments of the inventive technology provide new configurations for surfaces of an inner conductor shield and a mandrel that can increase production rates and decrease manufacturing defects. Embodiments of the inventive technology can allow for or enable significantly faster injection of an elastomeric material to form a second elastomeric layer (e.g., an intermediate insulation layer) that, in turn, provides faster filling of the cavity, reducing injection time, and reducing scorch. Consequently, the overall shorter cycle times in the manufacturing process and the resulting connector products are improved.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the subject matter.

Unless otherwise defined, all terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

As used herein, “monolithic” means an object that is a single, unitary piece formed or composed of a material without joints or seams. Alternatively, a unitary object can be a composition composed of multiple parts or components secured together at joints or seams.

Many alterations and modifications may be made by those having ordinary skill in the art, given the benefit of present disclosure, without departing from the spirit and scope of the disclosure. Therefore, it must be understood that the illustrated embodiments have been set forth only for the purposes of example, and that it should not be taken as limiting the inventions as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the inventive concepts of the disclosure.

We claim:

1. A cold shrink product for an electrical system, the cold shrink product comprising:
a tubular elastomeric layer including an inner surface, the inner surface defining a cavity and first retention features facing the cavity;
wherein the first retention features are configured to engage second retention features of a mandrel to resist relative displacement between the elastomeric layer and the mandrel during manufacture of the cold shrink product.

2. The cold shrink product of claim 1 including a second layer disposed on an outer surface of the elastomeric layer.

3. The cold shrink product of claim 2 including an outer layer surrounding the elastomeric layer, wherein:
the elastomeric layer and the outer layer are relatively arranged and configured such that a gap is defined therebetween; and
the second layer is disposed in the gap.

4. The cold shrink product of claim 3 wherein the second layer is bonded to an outer surface of the elastomeric layer and to an inner surface of the outer layer.

5. The cold shrink product of claim 3 wherein the second layer is elastomeric and the outer layer is elastomeric.

6. The cold shrink product of claim 5 wherein:
the elastomeric layer is an inner conductor shield;
the second layer is an electrical insulation layer; and
the outer layer is an electrical ground shield.

7. The cold shrink product of claim 1 wherein the elastomeric layer is formed of a semiconductive elastomer.

8. The cold shrink product of claim 1 wherein:
the cavity has a central axis; and
the first retention features include a plurality of protrusions arranged serially along the central axis and that extend radially inward toward the central axis and circumferentially about the central axis.

9. The cold shrink product of claim 8 wherein the protrusions are annular.

10. The cold shrink product of claim 8 wherein the protrusions form a sawtooth profile when viewed in a cross-sectional plane along the central axis.

11. The cold shrink product of claim 8 wherein each protrusion includes:
a front surface forming a first angle relative to the central axis; and
a rear surface forming a second angle relative to the central axis;
the first angle being steeper than the second angle such that the front surface resists displacement between the elastomeric layer and the mandrel during manufacture and the second surface facilitates removal of the mandrel from the elastomeric layer during manufacture.

12. The cold shrink product of claim 11 wherein each protrusion further includes a third surface extending axially between the front and rear surfaces, the third surface extending substantially parallel with the central axis.

13. The cold shrink product of claim 1 wherein:
the cold shrink product is an electrical connector including a protective housing and an electrical contact; and
the elastomeric layer forms at least a part of the protective housing.

14. The cold shrink product of claim 13 wherein the cold shrink product is an elbow connector.

15. The cold shrink product of claim 1 wherein the cold shrink product is a splice joint body configured to cover an electrical cable splice connection.

16. The cold shrink product of claim 1 wherein:
the cold shrink product includes an outer layer surrounding the elastomeric layer;
the elastomeric layer and the outer layer are relatively arranged and configured such that a gap is defined therebetween;
the cold shrink product further includes a second layer disposed in the gap;
the second layer is bonded to an outer surface of the elastomeric layer and to an inner surface of the outer layer;
the elastomeric layer is an inner conductor shield formed of a semiconductive elastomer;
the second layer is an electrical insulation layer formed of an electrically insulating elastomer;
the outer layer is an electrical ground shield formed of a semiconductive elastomer;
the cavity has a central axis;
the first retention features are a plurality of protrusions arranged serially along the central axis and that extend radially inward toward the central axis and circumferentially about the central axis; and
the protrusions are annular.

17. A method for forming a cold shrink product for an electrical system, the cold shrink product including a tubular elastomeric layer including an inner surface defining a cavity and first retention features facing the cavity, the cavity being configured to receive an electrical cable, the method comprising:
mounting the elastomeric layer on a mandrel such that the first retention features of the elastomeric layer engage second retention features of the mandrel; and
injecting a material along an outer surface of the elastomeric layer to form a second layer on an outer surface of the elastomeric layer, wherein engagements between the first and second retention features resist relative displacement between the elastomeric layer and the mandrel as the material is injected.

18. The method of claim 17 wherein mounting the elastomeric layer on the mandrel includes inserting the mandrel into the cavity of the elastomeric layer.

19. The method of claim 17 wherein injecting the material along the outer surface of the elastomeric layer includes injecting the material into a gap defined between the outer surface of the elastomeric layer and an inner surface of an outer layer.

20. A cold shrink product for an electrical system, comprising:
an inner conductor shield having an inner surface defining a generally cylindrical cavity for receiving an electrical cable, the generally cylindrical cavity having a central axis, the inner surface having a plurality of circumferential projections extending toward the central axis, each of the plurality of circumferential projections being longitudinally spaced along the central axis from an adjacent one the plurality of circumferential projections;
an outer insulation shield surrounding the inner conductor shield, the outer insulation shield being spaced away from the inner conductor shield; and
insulation material located between the inner conductor and the outer insulation shield.
